(19) United States
(12) Patent Application Publication
(10) Pub. No.: US 2022/0019222 A1
(43) Pub. Date: Jan. 20, 2022

(54) Unmanned Aerial Vehicle, Unmanned Aerial Vehicle Flight Control Device, Unmanned Aerial Vehicle Flight Control Method and Program

(71) Applicant: ACSL Ltd., Tokyo (JP)

(72) Inventors: Christopher Thomas Raabe, Chuo-ku, Tokyo (JP); Niklas Bergstrom, Setagaya-ku, Tokyo (JP)

(21) Appl. No.: 16/767,454

(22) PCT Filed: Nov. 28, 2017
(86) PCT No.: PCT/JP2017/042617

§ 371 Date: Sep. 4, 2020

(51) Int. Cl. G05D 1/00; B64D 47/08; B64C 39/02

(52) U.S. Cl. CPC G05D 1/0094; B64C 2201/127; B64C 39/024; B64D 47/08

(57) ABSTRACT

Provided are a flight control device, a flight control method, and the like for measuring the distance between the body of an aircraft and a target element during flight and controlling the distance in accordance with the measured value. This unmanned aircraft flight control device comprises: a distance sensor for measuring the distance between a target element and an unmanned aircraft that flies by control using an external input signal and/or pre-generated flight plan information, the distance sensor comprising an imaging camera that captures the target element, and a measured value determination circuit that determines a measured value of the distance using the captured image information; and a control signal generation circuit that generates a control signal for controlling the distance between the target element and the unmanned aircraft during flight, in accordance with the distance measurement value measured by the distance sensor.

### TECHNICAL FIELD

The present invention relates to an unmanned aerial vehicle (unmanned aircraft), an unmanned aerial vehicle flight control device, an unmanned aerial vehicle flight control method and a program. More specifically, the present invention relates to a flight control device, a flight control method, etc., for controlling a distance between an unmanned aerial vehicle and an object element.

### BACKGROUND ART

In recent years, unmanned aerial vehicle that control flight by controlling rotation speeds of a plurality of rotor blades have been distributed in the market and widely used for industrial purposes, such as photographic surveys, crop-dusting and goods transportation, or recreational purposes.

In an example, an unmanned aerial vehicle flies according to an external input signal input from an external input device such as a proportional controller; however, where an unmanned aerial vehicle is flying at a distance at which an operator cannot view the unmanned aerial vehicle, even if the airframe of the unmanned aerial vehicle is approaching a structure or the like and is at the risk of collision with the structure or the like, the operator cannot perceive the risk and thus may fail to avoid such collision. Also, even where an unmanned aerial vehicle flies on a preset flight plan route by execution of an autonomous control program by a flight controller, if there is an obstacle or the like not taken into consideration in creation of the flight plan route, the airframe of the unmanned aerial vehicle may fail to avoid collision with the obstacle or the like.

### CITATION LIST

### Patent Literature

Patent Literature 1: Japanese Paten Laid-Open No. 2012-198077

Non-Patent Literature 1: Toshiba Corporation, “Development of an Imaging Technique That Can Simultaneously Acquire a Color Image and Distance Image from a Single Image Taken with a Monocular Camera”, [online], Toshiba Corporation, Corporate Research & Development Center, [searched on Oct., 16, 2017], Internet <URL:https://www.toshiba.co.jp/rdc/detail/1606_01.htm>

Non-Patent Literature 2: Vinay R., “What is OpenCV?”, [online], Intel, [searched on Oct. 23, 2017], Internet <URL: https://software.intel.com/en-us/articles/what-is-opencv>

Non-Patent Literature 3: Andrew J. Davison, et al., “MonoSLAM: Real-Time Single Camera SLAM”, IEEE TRANSACTIONS ON PATTERN ANALYSIS AND MACHINE INTELLIGENCE, VOL. 29, NO. 6, JUNE 2007, [online], [searched on Oct. 20, 2017], Internet <URL:

https://www.doc.ic.ac.uk/˜ajd/Publications/davison_etal_pami2007.pdf>

Non-Patent Literature 4: Georg Klein, “Parallel Tracking and Mapping for Small AR Workspaces—Source Code”, [online], Georg Klein Home Page, [searched on Oct. 20, 2017], Internet <URL: http://www.robots.ox.ac.uk/˜gk/PTAM/>

Non-Patent Literature 5: Georg Klein, et al., “Parallel Tracking and Mapping for Small AR Workspaces”, Proc. International Symposium on Mixed and Augmented Reality (ISMAR '07, Nara), [online], [searched on Oct. 20, 2017], Internet <URL: http://www.robots.ox.ac.uk/˜gk/publications/KleinMurray2007ISMAR.pdf>

Non-Patent Literature 6: Shuichi Maki and three others, “Development of Mobile Mapping System Using Laser Range Finder”, [online], ITE Winter Annual Convention 2014, [searched on Oct. 20, 2017], Internet <URL: https://www.jstage.jst.go.jp/article/itewac/2014/0/2014_4-13-1_/_pdf>

### SUMMARY OF INVENTION

### Technical Problem

In view of the above, an object of the present invention is to provide a flight control device, a flight control method, etc., for measuring a distance between and an aircraft body and an object element and controlling the distance according to a measurement value during flight.

Solution to Problem

In order to achieve the above object, the present invention provides an unmanned aerial vehicle flight control device including: a distance sensor that measures a distance between an unmanned aerial vehicle and an object element, the unmanned aerial vehicle flying according to control using an external input signal and/or in advance-generated flight plan information, the distance sensor including a shooting camera that takes an image of (shoots) the object element and a measurement value determination circuit that determines a measurement value of the distance using information of the taken image; and a control signal generation circuit that generates a control signal for controlling the distance between the unmanned aerial vehicle and the object element during flight, depending on the measurement value of the distance measured by the distance sensor. Here, neither “depending on” the measurement value of the distance nor “generates a control signal for controlling the distance” means that it is necessary to generate a control signal for controlling the distance whatever the measurement value of the distance is. In an example, a control signal for controlling the distance is generated only if the measurement value of the distance falls outside a predetermined range.

The unmanned aerial vehicle may be an unmanned aerial vehicle that flies according to control using at least the external input signal, the external input signal may be a signal input in real time from an external input device during flight of the unmanned aerial vehicle, and the control signal may be a signal obtained by changing the external input signal according to the measurement value of the distance.

The unmanned aerial vehicle may be an unmanned aerial vehicle that flies according to control using at least the flight plan information, and the flight plan information may be flight plan information generated in advance before the flight by execution of a program by a computer.

The measurement value determination circuit may be integrated in the control signal generation circuit.

The control signal generation circuit may be configured to, if the measurement value is smaller than a first reference value, generate a control signal for making the unmanned aerial vehicle move away from the object element. However, as a condition for “generating a control signal for making the unmanned aerial vehicle move away from the object element”, some sort of additional condition may be provided in addition to the condition that “the measurement value is smaller than a first reference value”, and also, even if the condition that “the measurement value is smaller than a first reference value” is not met, it is not intended to prohibit “generating a control signal for making the unmanned aerial vehicle move away from the object element”.

The control signal generation circuit may be configured to, if the measurement value is larger than a second reference value that is equal to or larger than the first reference value, generate a control signal for making the unmanned aerial vehicle move toward the object element. However, as a condition for “generating a control signal for making the unmanned aerial vehicle move toward the object element”, some sort of additional condition may be provided in addition to the condition that “the measurement value is larger than a second reference value that is equal to or larger than the first reference value”, and also, even if the condition that “the measurement value is larger than a second reference value that is equal to or larger than the first reference value” is not met, it is not intended to prohibit “generating a control signal for making the unmanned aerial vehicle move toward the object element”.

The first reference value and the second reference value may be equal to each other.

The control signal generation circuit may be configured to: if the measurement value is smaller than the first reference value and the measurement value decreases over time, generate a control signal for making the unmanned aerial vehicle move away from the object element; and if the measurement value is larger than the second reference value and the measurement value increases over time, generate a control signal for making the unmanned aerial vehicle move toward the object element. However, as a condition for “generating a control signal for making the unmanned aerial vehicle move away from the object element” and a condition for “generating a control signal for making the unmanned aerial vehicle move toward the object element”, some sort of additional condition may be provided in addition to the condition that “the measurement value is smaller than the first reference value and the measurement value decreases over time” and the condition that “the measurement value is larger than the second reference value and the measurement value increases over time”, respectively, and also, even if the condition that “the measurement value is smaller than the first reference value and the measurement value decreases over time” and the condition that “the measurement value is larger than the second reference value and the measurement value increases over time” are not met, respectively, it is not intended to prohibit “generating a control signal for making the unmanned aerial vehicle move away from the object element” and “generating a control signal for making the unmanned aerial vehicle move toward the object element”.

The flight control device may further include an external environment shooting camera that performs image shooting (taking of an image) in a direction that is different from a direction of taking of image by the shooting camera.

The flight control device may further include a relative position measurement sensor for measuring a relative position of the unmanned aerial vehicle relative to an element present around the unmanned aerial vehicle.

The object element may be an inspection object structure (structure to be inspected).

Also, the present invention provides an unmanned aerial vehicle including the above flight control device.

Also, the present invention provides an unmanned aerial vehicle flight control method including the steps of; measuring a distance between an unmanned aerial vehicle and an object element, the unmanned aerial vehicle flying according to control using an external input signal and/or in advance-generated flight plan information, by taking an image of (shooting) the object element and determining a measurement value of the distance using information of the taken image; and generating a control signal for controlling the distance between the unmanned aerial vehicle and the object element during flight, depending on the measurement value of the distance.

Also, the present invention provides a program for making a measurement value determination circuit determine a measurement value of a distance between an unmanned aerial vehicle and an object element, the unmanned aerial vehicle flying according to control using an external input signal and/or in advance-generated flight plan information, using information of an image of the object element, the image being taken by a shooting camera, and making a control signal generation circuit generate a control instruction value for controlling the distance between the unmanned aerial vehicle and the object element during flight, depending on the measurement value of the distance. The program can also be provided in the form of a program product with the program recorded in a computer-readable non-volatile (non-transitory) recording medium such as a hard disk, a CD-ROM or an arbitrary (any) semiconductor memory (the program may be recorded in a single recording medium or may be recorded in a distributed manner in two or more recording mediums).

### Advantageous Effects of Invention

Making an unmanned aerial vehicle fly while controlling a distance between the unmanned aerial vehicle and an object element according to the present invention enables at least reduction of a risk of collision of the unmanned aerial vehicle with an inspection object structure, an obstacle or the like during the flight.

### BRIEF DESCRIPTION OF DRAWINGS

FIG. 1 is a perspective view of an unmanned aerial vehicle, which is an embodiment of the present invention.

FIG. 2 is a diagram of the unmanned aerial vehicle in FIG. 1 as viewed from the negative direction of z.

FIG. 3 is a block diagram illustrating a configuration of the unmanned aerial vehicle in FIG. 1.

FIG. 4 is a flowchart for illustrating measurement of a distance between an unmanned aerial vehicle and an inspection object structure and distance control according to a measurement value.

FIG. 5 is a diagram for illustrating a principle of distance measurement by a stereo camera (cited from FIG. 1 of Japanese Patent Laid-Open No. 2012-198077, with only the definition of the coordinate axes changed).

FIG. 6 is a block diagram illustrating configurations of a stereo camera and a measurement value determination circuit (cited from FIG. 5 of Japanese Patent Laid-Open No. 2012-198077, with only the reference numerals changed).

FIG. 7A is a diagram illustrating an unmanned aerial vehicle that flies a distance d away from an inspection object structure.

FIG. 7B is a diagram for illustrating that if a distance d between an unmanned aerial vehicle and an inspection object structure is smaller than a first reference value D₁, control for making the unmanned aerial vehicle move away from the inspection object structure is performed.

FIG. 7C is a diagram for illustrating that if a distance d between an unmanned aerial vehicle and an inspection object structure is larger than a second reference value D₂, control for making the unmanned aerial vehicle move toward the inspection object structure is performed.

FIG. 7D is a diagram for illustrating that when the first reference value D₁ and the second reference value D₂ are equal to each other, control for bringing a distance between an unmanned aerial vehicle and an inspection object structure into D₁=D₂ is performed.

FIG. 8A is a diagram illustrating that when a distance between an unmanned aerial vehicle and an inspection object structure is controlled so that D₁=D₂, flight of the unmanned aerial vehicle is substantially limited within a two-dimensional plane.

FIG. 8B is a diagram illustrating that when a distance between an unmanned aerial vehicle and an inspection object element is controlled so that D₁=D₂, flight of the unmanned aerial vehicle is substantially limited within a one-dimensional line.

FIG. 9 illustrates an alteration of the flowchart in FIG. 4.

FIG. 10A is a diagram of a prototype of an unmanned aerial vehicle, which is an embodiment of the present invention, as viewed from the positive direction of z.

FIG. 10B is a photograph of a prototype of an unmanned aerial vehicle, which is an embodiment of the present invention, as viewed from a direction slightly oblique to a positive direction of z.

FIG. 11 is a block diagram illustrating the configuration of the prototype in FIGS. 10A and 10B.

FIG. 12 is a diagram illustrating a distance setting knob on an external input device for operating the prototype in FIGS. 10A and 10B.

FIG. 13 is a diagram illustrating a takeoff pad to be used for initial settings of the prototype in FIGS. 10A and 10B.

### DESCRIPTION OF EMBODIMENT

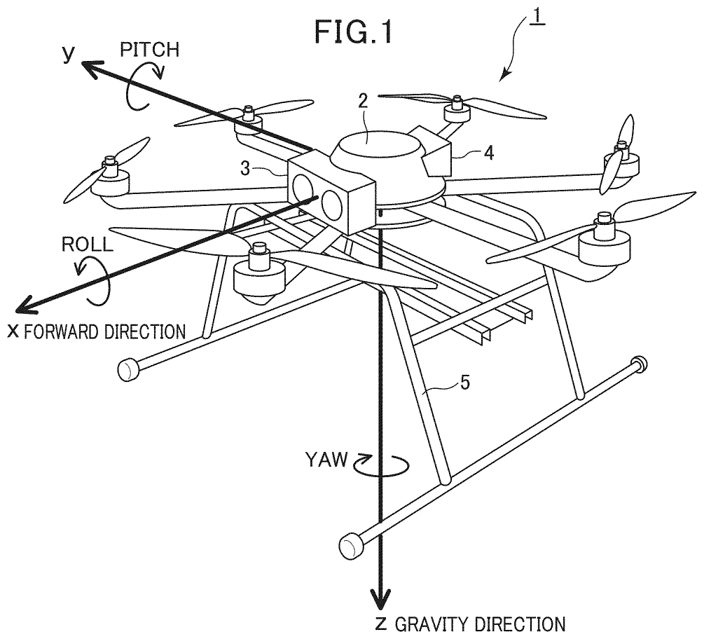

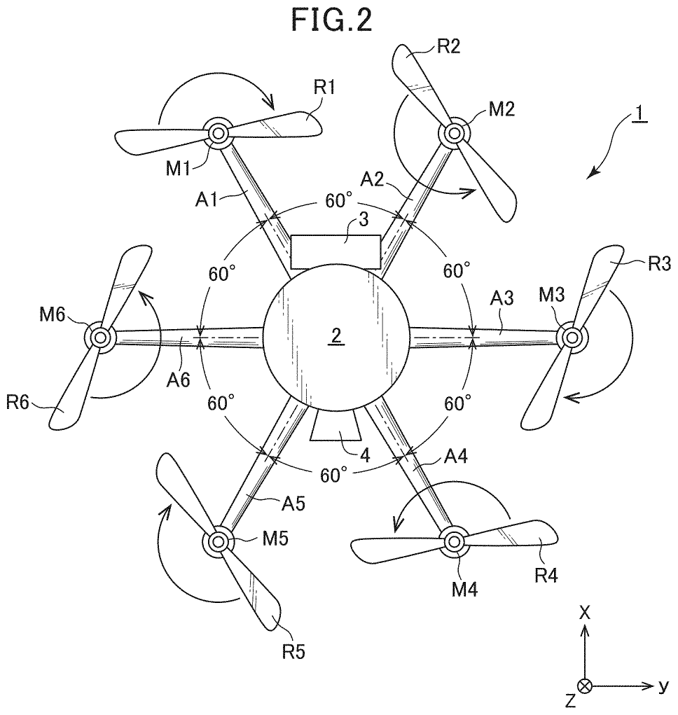

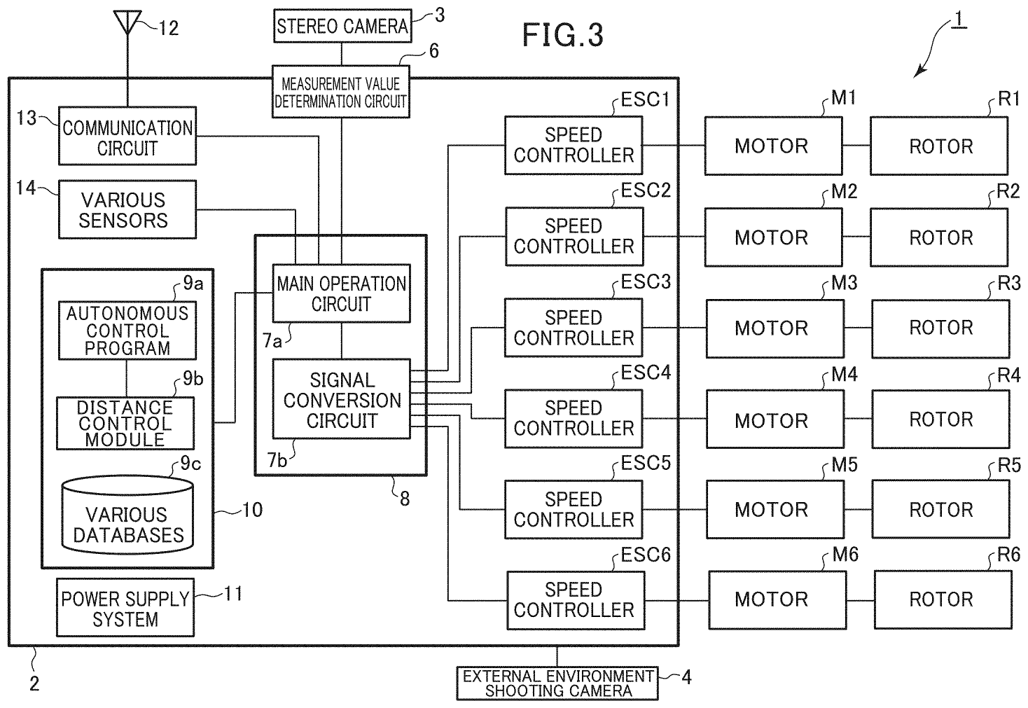

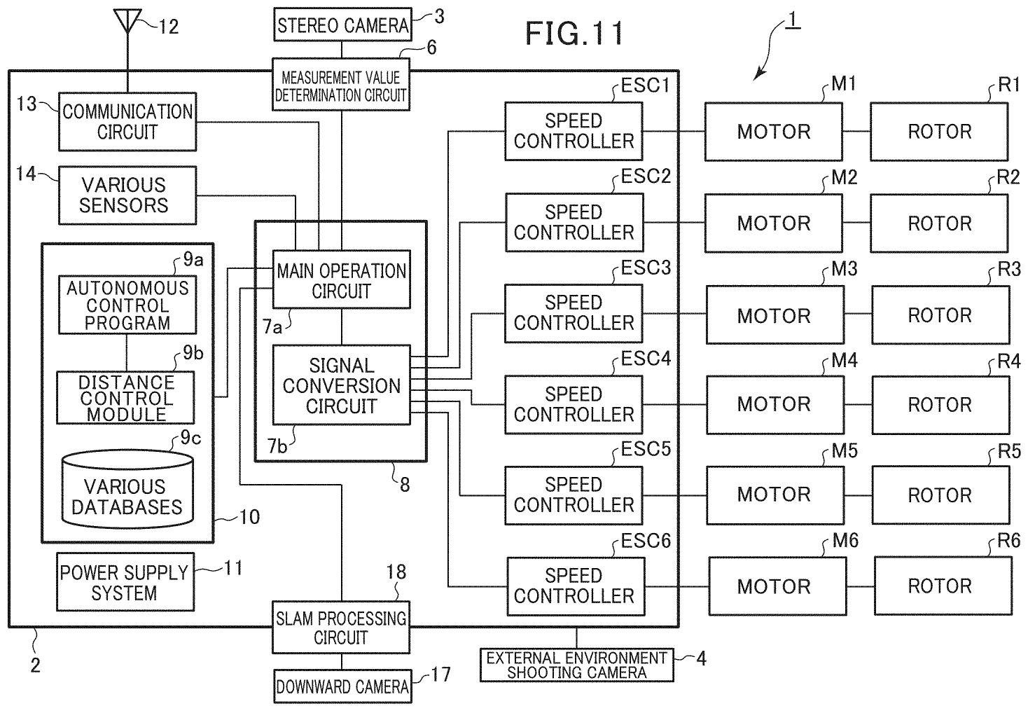

An unmanned aerial vehicle, an unmanned aerial vehicle flight control device, an unmanned aerial vehicle flight control method and a program according to an embodiment of the present invention will be described below with reference to the drawings. However, it should be noted that: an unmanned aerial vehicle, an unmanned aerial vehicle flight control device, an unmanned aerial vehicle flight control method and a program according to the present invention are not limited to the below-described specific modes; and appropriate changes are possible within the scope of the present invention. For example, an unmanned aerial vehicle according to the present invention may be of a manual type or an autonomous flight type or an unmanned aerial vehicle of a semi-manual type, which is a combination thereof, and a functional configuration of the unmanned aerial vehicle is not limited to those illustrated in FIG. 3 or FIG. 11 and an arbitrary configuration may be employed as long as such configuration enables the unmanned aerial vehicle to operate in a similar manner, and for example, an operation to be performed by a plurality of components may be performed by a single component, such as one or more of a communication circuit, a measurement value determination circuit and a SLAM processing circuit being integrated in a main operation circuit, or an operation to be performed by an illustrated single component may be performed by a plurality of components, such as a function of a main operation circuit being distributed to a plurality of operation circuits. As an example, in FIG. 3, a measurement value determination circuit is illustrated as a piece of hardware (for example, a circuit that includes, e.g., a processor and a memory and serves as a digital signal processing section attached in advance to a commercially available stereo camera) that is separate from a control signal generation circuit; however, a measurement value determination circuit may be integrated in a control signal generation circuit by employing a configuration in which, e.g., such digital signal processing is performed by a main operation circuit (a shooting camera is configured by two monocular cameras and data of respective images shot by the monocular cameras are output to a main operation circuit). An autonomous control program for an unmanned aerial vehicle may be one recorded in a recording device such as a hard disk drive and to be read and executed by a main operation circuit (the illustrated autonomous control program may be decomposed into a plurality of program modules including, e.g., a distance control module or another arbitrary program may be executed by, e.g., the main operation circuit) or an operation that is similar to the above may be performed by an embedded system using, e.g., a microcomputer. Neither an unmanned aerial vehicle nor an unmanned aerial vehicle flight control device according to the present invention necessarily needs to include all of the components indicated in the below embodiment, and neither an unmanned aerial vehicle control method nor a program according to the present invention need to include all of the indicated method steps or instructions for making processing devices execute the method steps. Rotor blades for making the unmanned aerial vehicle fly are also not limited to six rotors R1 to R6 such as illustrated in, e.g., FIGS. 1 and 2, and an arbitrary number of rotor blades (arbitrary rotor blades such as rotors or propellers), for example, four rotors R1 to R4, may be employed. The unmanned aerial vehicle may be an arbitrary unmanned aerial vehicle such as a single rotor-type helicopter or a fixed-wing aircraft. The unmanned aerial vehicle may have any airframe size.

### Configuration of Unmanned Aerial Vehicle and Overview of Flight Control

FIG. 1 is a perspective view of an unmanned aerial vehicle, which is an embodiment of the present invention, and FIG. 2 is a diagram of the unmanned aerial vehicle as viewed from the negative direction of z (landing gear (landing leg) 5 omitted). The unmanned aerial vehicle 1 includes a body portion 2, six motors M1 to M6 (FIG. 2) to be driven according to control signals from the body portion 2, six rotors (rotor blades) R1 to R6 that upon the respective motors M1 to M6 being driven, rotate and make the unmanned aerial vehicle 1 fly, arms A1 to A6 (FIG. 2) connecting the body portion 2 and the respective motors M1 to M6, a stereo camera 3 for performing shooting (taking an image of) a forward area during flight, an external environment shooting camera 4 for performing shooing an area other than the forward area during flight, and a landing gear 5 that contributes to, e.g., prevention of rollover during takeoff/landing. As illustrated in FIG. 1, a roll angle, a pitch angle and a yaw angle are defined as rotation angles around an x-axis, a y-axis and a z-axis, respectively. Also, a throttle amount is defined as an amount corresponding to ascending/descending of the airframe (number of rotations, rotational frequency of the entirety of the rotors R1 to R6). As illustrated in FIG. 2, the rotors R1, R3, R5 rotate clockwise as viewed from the negative direction of z, and the rotors R2, R4, R6 rotate counterclockwise as viewed from the negative direction of z. In other words, the adjacent rotors rotate in opposite directions. The six arms A1 to A6 are equal in length and as illustrated in FIG. 2, are disposed with a pitch of 60°. In addition, the unmanned aerial vehicle 1 may be equipped with, e.g., another camera and/or a payload depending on, e.g., the intended use (not illustrated).

FIG. 3 is a block diagram illustrating a configuration of the unmanned aerial vehicle in FIG. 1. The body portion 2 of the unmanned aerial vehicle 1 includes: a main operation circuit 7a that includes, e.g., a processor and a temporary memory and performs various arithmetic operations and a signal conversion circuit 7b that includes, e.g., a processor and a temporary memory and performs processing for, e.g., converting data of control instruction values obtained by an arithmetic operation by the main operation circuit 7a into pulse signals (PWM (pulse width modulation) signals) for the motors M1 to M6 (operation circuit including the main operation circuit 7a and the signal conversion circuit 7b is referred to as “control signal generation circuit 8”); electric speed controllers (ESCs (electric speed controllers) ESC1 to ESC6 that convert the pulse signals generated by the control signal generation circuit 8 into driving currents for the motors M1 to M6; a communication antenna 12 and a communication circuit 13 that perform transmission/reception of various data signals to/from the outside; a sensor section 14 including various sensors such as a GPS (Global Positioning System) sensor, an attitude sensor, an altitude sensor and an azimuth sensor; a recording apparatus 10 formed of a recording device, such as a hard disk drive, that records, e.g., an autonomous control program 9a (including a distance control module 9b) and various databases 9c; and a power supply system 11 including a battery device such as a lithium polymer battery or a lithium ion battery and/or a power distribution system for power distribution to the respective components. Also, the unmanned aerial vehicle 1 includes: the stereo camera 3; a measurement value determination circuit 6 that includes, e.g., a processor and a temporary memory and performs digital signal processing of information of images shot by the stereo camera 3 to determine a measurement value of a distance; and the external environment shooting camera 4 that during flight, shoots (takes an image) in a direction that is different from that of the stereo camera 3 and records the image in a memory thereof (information of the image shot (taken) by the external environment shooting camera 4 may be recorded in the recording apparatus 10 as needed).

In addition, the unmanned aerial vehicle 1 may include, e.g., an arbitrary function section or arbitrary information depending on the function and usage. As an example, where the unmanned aerial vehicle 1 autonomously flies according to a flight plan (autonomous flight mode), flight plan information indicating a flight plan including, e.g., some sort of routes, regulations to be followed during flight, such as a flight plan route that is an aggregate of a flight start position, a destination position and check point positions (a latitude, a longitude and an altitude) via which the unmanned aerial vehicle 1 reaches the destination position from the start position, a speed limit and an altitude limit (information generated in advance before flight using, e.g., conditions and a route input through an external interface by, e.g., a user of the unmanned aerial vehicle 1, by execution of a flight plan information generation program by an external computer) are recorded in the recording apparatus 10, information of a two-dimensional map or a three-dimensional map of an area around the flight plan route included in the flight plan for the unmanned aerial vehicle 1 is recorded in the recording apparatus 10, and upon the main operation circuit 7a reading the flight plan information and executing the autonomous control program 9a, the unmanned aerial vehicle 1 flies according to the flight plan. More specifically, a current position, a current speed, etc., of the unmanned aerial vehicle 1 are determined based on information obtained from various sensors of the sensor section 14, the main operation circuit 7a performs an arithmetic operation to calculate control instruction values relating to a throttle amount, a roll angle, a pitch angle and a yaw angle by comparing the current position, the current speed, etc., with target values, such as the flight plan route, the speed limit and the altitude limit, prescribed in the flight plan, and the main operation circuit 7a converts these control instruction values into control instruction values relating to rotation speeds of the rotors R1 to R6 and transmits the control instruction values to the signal conversion circuit 7b, and the signal conversion circuit 7b converts data indicating the control instruction values relating to the rotation speeds into pulse signals and transmits the pulse signals to the speed controllers ESC1 to ESC6, and the speed controllers ESC1 to ESC6 convert the pulse signals into drive currents and output the drive currents to the respective motor M1 to M6 to control driving of the motors M1 to M6 to control, e.g., the rotation speeds of the rotors R1 to R6, whereby flight of the unmanned aerial vehicle 1 is controlled. As an example, control for, e.g., increasing the rpm of the rotors R1 to R6 for a control instruction for increasing the altitude of the unmanned aerial vehicle 1 (decreasing the rpm of the rotors R1 to R6 where the altitude is lowered) and decreasing the rpm of the rotors R1, R2 and increasing the rpm of the rotors R4, R5 for a control instruction for accelerating the unmanned aerial vehicle 1 in a forward direction (positive direction of x in FIG. 1) (opposite control in the case of decelerating) is performed. Flight record information pieces such as a flight route actually taken by the unmanned aerial vehicle 1 (e.g., positions of the airframe of the unmanned aerial vehicle 1 at respective times) and various types of sensor data are recorded in various databases 9c during flight as needed.

Note that where the unmanned aerial vehicle 1 flies according to external input instruction values (instruction values relating to the throttle amount, the roll angle, the pitch angle and the yaw angle) indicated by external input signals received in real time by the communication antenna 12 and the communication circuit 13 during flight from an external input device such as a proportional controller (manual mode), the main operation circuit 7a performs an arithmetic operation to calculate control instruction values for the rotation speeds of the rotors R1 to R6 by execution of the autonomous control program 9a (separate control program recorded in the recording apparatus 10 where the unmanned aerial vehicle 1 is configured as one including an airframe dedicated for manual control using an external input device) using the external input instruction values, and the signal conversion circuit 7b converts the resulting data into pulse signals, and flight control is performed by controlling the rotation speeds of the rotors R1 to R6 using the speed controllers ESC1 to ESC6 and the motors M1 to M6 in such a manner as above.

Alternatively, where the unmanned aerial vehicle 1 is made to fly in an attitude control mode in which autonomous control is performed only for the attitude of the airframe (an example of a semi-manual mode), the main operation circuit 7a executes the autonomous control program 9a using data indicating attitude information obtained by measurement by the attitude sensor (e.g., a gyroscope sensor or a magnetic sensor) of the sensor section 14, to perform an arithmetic operation to calculate attitude control instruction values (instruction values relating to the roll angle, the pitch angle and the yaw angle) by comparing between the data from the attitude sensor and a target value for the attitude, for example, perform an arithmetic operation to calculate (combined) control instruction values relating to the throttle amount, the roll angle, the pitch angle and the yaw angle by combining the attitude control instruction values and external input instruction values (instruction values relating to the throttle amount, the roll angle, the pitch angle and the yaw angle) indicated by external input signals received from the external input device, and convert the control instruction values into control instruction values relating to the rotation speeds of the rotors R1 to R6 (the arithmetic operations and conversion are performed by execution of the autonomous control program 9a by the main operation circuit 7a), whereby flight is controlled in such a manner as above.

As examples of autonomous flight-type unmanned aerial vehicle, Mini Surveyor ACSL-PF1 (Autonomous Control Systems Laboratory, Ltd.), Snap (Vantage Robotics), AR. Drone 2.0 (Parrot), Bebop Drone (Parrot), etc., are commercially available. In the below-described flight control of the unmanned aerial vehicle 1, the unmanned aerial vehicle 1 basically flies according to external input signals from, e.g., the external input device and autonomous control is performed only for the attitude and the distance to an object element; however, the flight control including the distance control is also possible in an unmanned aerial vehicle 1 that performs fully autonomously controlled flight or fully externally controlled flight.

### Distance Measurement and Distance Control According to Measurement Value

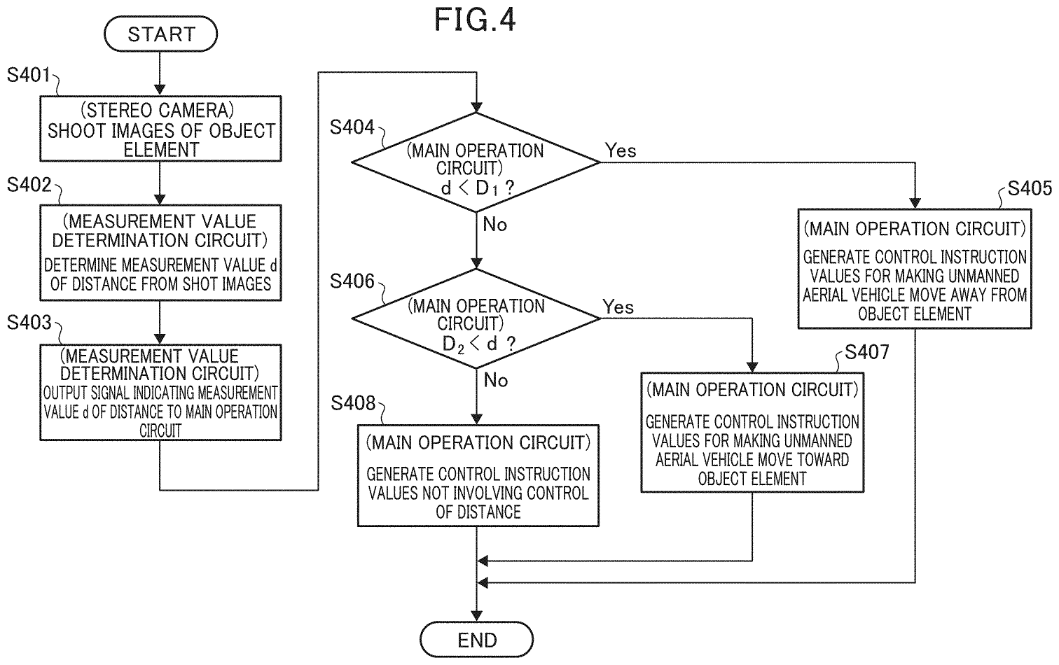

In the unmanned aerial vehicle 1 according to the present embodiment, during flight, a distance between the unmanned aerial vehicle 1 and an object element such as an inspection object structure is measured using the stereo camera 3 and the measurement value determination circuit 6, the control signal generation circuit 8 that has received a signal indicating a measurement value of the distance from the measurement value determination circuit 6 in real time generates control signals for controlling the distance in real time according to the measurement value of the distance during the flight (the main operation circuit 7a generates control instruction values and the signal conversion circuit 7b converts the control instruction value data into control signals in the form of pulse signals) to perform distance control. FIG. 4 is a flowchart of processing including distance measurement using the stereo camera 3 and the measurement value determination circuit 6 and subsequent control instruction value generation processing performed by execution of the autonomous control program 9a including the distance control module 9b by the main operation circuit 7a.

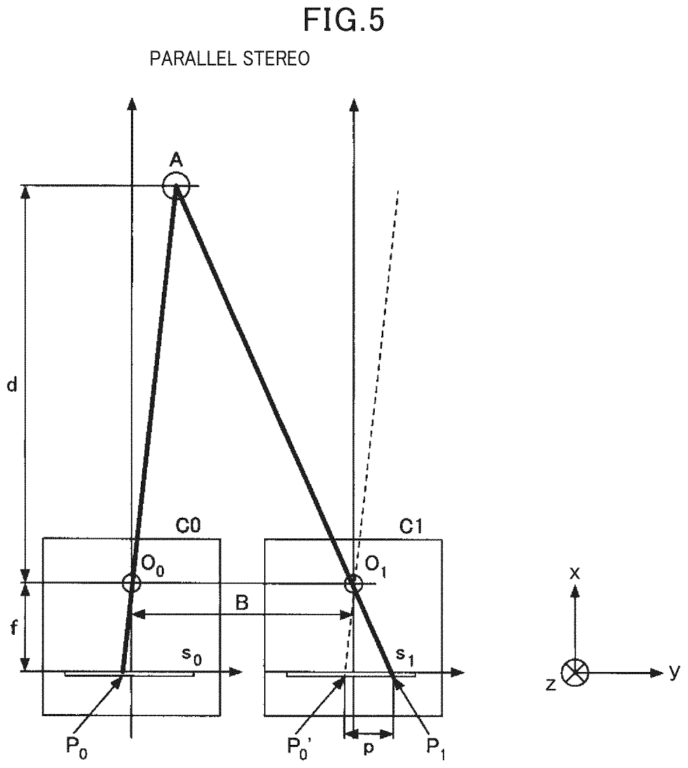

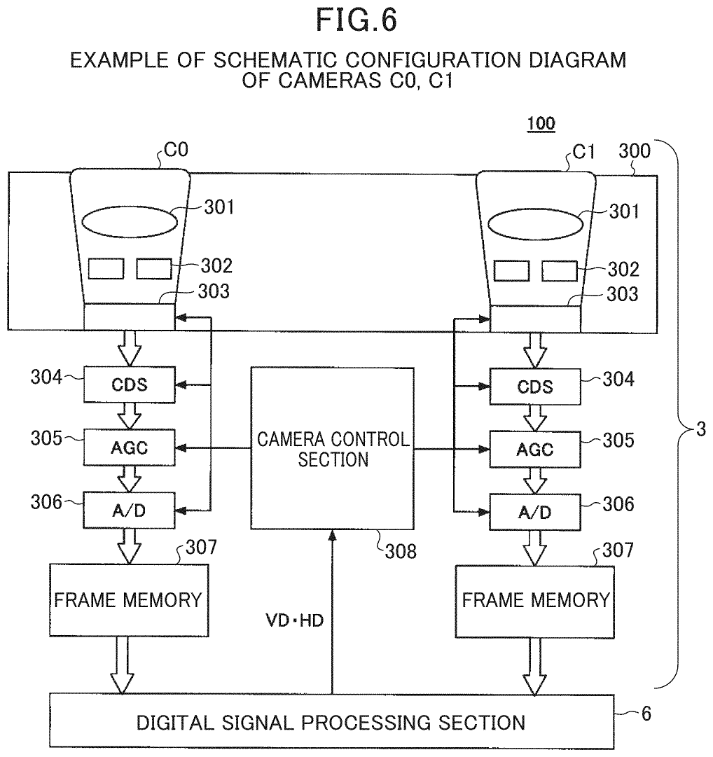

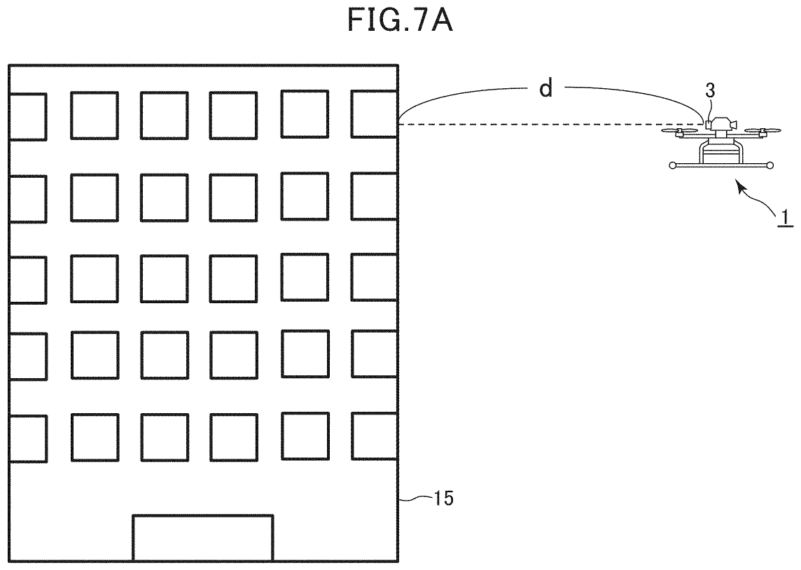

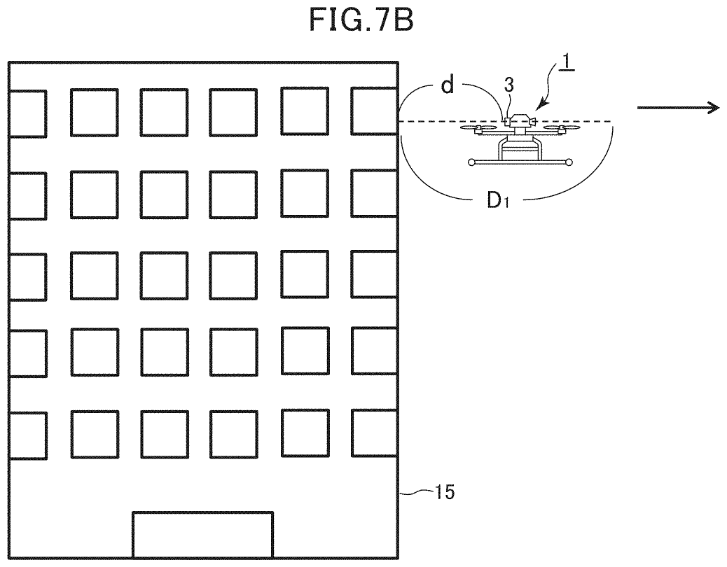

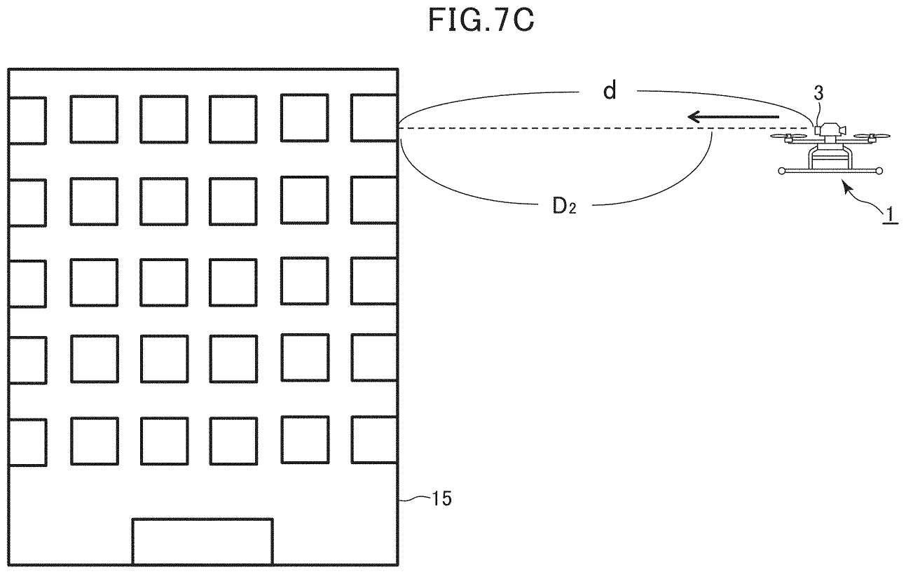

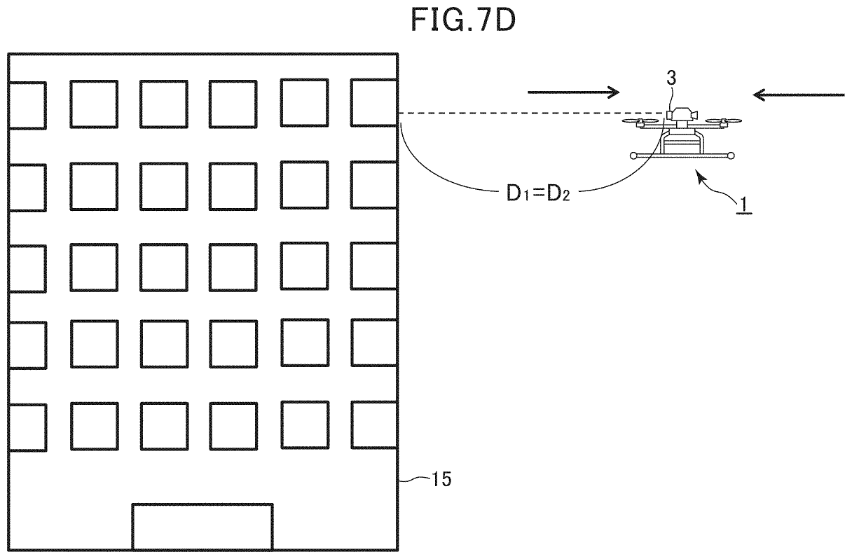

First, during flight of the unmanned aerial vehicle 1, the stereo camera 3 shoots (takes images of) an object element (later-described inspection object structure 15a in, e.g., FIG. 7A) (step S401) and the measurement value determination circuit 6 determines a measurement value d of a distance between the unmanned aerial vehicle 1 and the inspection object structure 15a using information of the images simultaneously shot by left and right cameras C0, C1 (see FIGS. 5 and 6 referred to later) (step S402). The measurement value determination circuit 6 outputs a signal indicating the measurement value d of the distance to the main operation circuit 7a (step S403). A principle of distance measurement and a configuration of the stereo camera 3 will be described below with citations from the description of Patent Literature 1 (Japanese Patent Laid-Open No. 2012-198077, Inventor: Shin Aoki, Title of Invention: “Stereo Camera Device and Parallax Image Generating Method”, Applicant: Ricoh Company, Ltd., Application number: Japanese Patent Application No. 2011-61729, filed on Mar. 18, 2011).

### Distance Measurement Using Stereo Camera

FIG. 5 is a citation of FIG. 1 in Patent Literature 1 (with only the definition of the coordinate axes changed). The principle of distance measurement using the stereo camera 3 will be described with reference to FIG. 5 as described below using a citation of paragraphs [0003] and [0004] of Patent Literature 1.

“[0003]

FIG. 1 is a diagram for describing a principle of distance measurement using a parallel stereo camera. Cameras C₀ and C₁ are installed a distance B away from each other. A focal length, optical centers and imaging surfaces of the cameras C0 and C1 are as follows.
Focal length: f,
Optical center: O₀, O₁
Imaging surface: s₀, s₁

An image of a subject A located at a position a distance d away from the optical center O₀ of the camera C0 in an optical axis direction is formed at P₀, which is a point of intersection between straight line A-O₀ and the imaging surface s₀. On the other hand, in the camera C1, an image of the same subject A is formed at a position P₁ on the imaging surface s₁. Here, P₀′ is a point of intersection between a straight line extending through the optical center O₁ of the camera C1 and parallel to straight line A-O₀ and the imaging surface s₁, and p is a distance between points P₀′ and P₁.” (paragraph [0003] of Patent Literature 1 cited)

“[0004]

P₀′ is a position that is the same as P₀ in the image on the camera C0, the distance p represents an amount of difference in position between images of the same subject shot by the two cameras on the image and is called parallax.

Since triangle A-O₀-O₁ and triangle O₁-P₀′-P₁ are similar to each other,

d=Bf/p

can be obtained. If the distance B between the cameras C0 and C1 (baseline length) and the focal length f are known, the distance d can be obtained from the parallax p.” (paragraph [0004] of Patent Literature 1 cited)

The principle of distance measurement using a stereo camera has been described above with citations of FIG. 1 and paragraphs [0003] and [0004] of Patent Literature 1. Although in the below, as illustrated in FIG. 5, the distance d between the subject (object element) A and the optical centers O₀, O₁ in the optical axis direction is a “distance between the unmanned aerial vehicle 1 and the object element A”, the “distance” can arbitrarily be defined: for example, the “distance between the unmanned aerial vehicle 1 and the object element A” is defined as a distance between the subject (object element) A and the imaging surfaces s₀, s₁ in the optical axis direction=d+f. The “distance d” in the below description is not limited to d as defined in Expression d=Bf/p above and may be a “distance” arbitrarily defined such as the above.

FIG. 6 is a block diagram illustrating configurations of the stereo camera 3 and the measurement value determination circuit 6, which is a citation of FIG. 5 of Patent Literature 1 with the reference numerals changed. Citing Paragraphs [0030] to [0036] of Patent Literature 1 (with the reference numerals changed), the configurations will be described below.

“[0030]

### Configuration

FIG. 5 illustrates an example of a schematic configuration diagram of a stereo camera 3. In a camera section 300, a right camera C1 and a left camera C0 are disposed. The right camera C1 and the left camera C0 each include a same lens and a same CMOS image sensor, and the right camera C1 and the left camera C0 are disposed in such a manner that respective optical axes thereof are parallel to each other and respective imaging surfaces of the two cameras are in a same plane. The left camera C0 and the right camera C1 each include a same lens 301, a same diaphragm 302 and a same CMOS image sensor 303.” (paragraph [0030] of Patent Literature 1 cited. However, the reference numerals have been changed.)

“[0031]

The CMOS image sensor 303 operates with a control signal as an input, the control signal being output by a camera control section 308. The CMOS image sensor 303 is a 1000×1000-pixel monochromatic image sensor, and the lens 301 has a characteristic of forming an image with a field of view of 80 degrees with one side and 160 degrees with both sides in up-down and left-right, within an imaging range of the CMOS image sensor 303 by means of an equidistance projection method.” (paragraph [0031] of Patent Literature 1 cited. However, the reference numerals have been changed.)

“[0032]

Note that the characteristic of the lens is not limited to the equidistance projection characteristic, and a lens used as a fish-eye lens, such as those having a characteristic of equisolid angle projection or orthographic projection, or a lens having, e.g., a central projection characteristic of causing strong barrel distortion may be employed. Like those with equidistance projection, each of these lenses has a small magnification factor for a peripheral area of an image in comparison with those with central projection, and thus, effects that are equivalent to those of the present embodiment can be obtained.” (paragraph [0032] of Patent Literature 1 cited)

“[0033]

Furthermore, even where a lens having a central projection characteristic that causes only small distortion is used, effects of similar tendency can be obtained by reducing the number of pixels of a deformed image.” (paragraph [0033] of Patent Literature 1 cited)

“[0034]

An image signal output by the CMOS image sensor 303 is output to a CDS 304 and subjected to denoising using correlated double sampling, is subjected to gain control according to a strength of the signal by an AGC 305 and is subjected to A/D conversion by an A/D 306. The image signal is stored in a frame memory 307 capable of storing an entirety of the CMOS image sensor 303.” (paragraph [0034] of Patent Literature 1 cited. However, the reference numerals have been changed.)

“[0035]

The image signal stored in the frame memory 307 is subjected to, e.g., distance calculation by a digital signal processing section 6, and depending on the specifications, is subjected to format conversion and displayed on display means of, e.g., liquid-crystal. The digital signal processing section 6 is an LSI including, e.g., a DSP, a CPU, a ROM and a RAM. Later-described functional blocks are, for example, provided in the form of hardware or software by the digital signal processing section 6. Note that the camera control section 308 may be disposed in the digital signal processing section 6 and the illustrated configuration is a mere example.” (paragraph [0035] of Patent Literature 1 cited. However, the reference numerals have been changed.)

“[0036]

The digital signal processing section 6 outputs respective pulses of a horizontal synchronous signal HD, a vertical synchronous signal VD and a clock signal to the camera control section 308. Alternatively, it is possible that the camera control section 308 generates a horizontal synchronous signal HD and a vertical synchronous signal VD. The camera control section 308 includes a timing generator and a clock driver and generates control signals for driving the CMOS image sensor 303 from HD, VD and the clock signal.” (paragraph [0036] of Patent Literature 1 cited. However, the reference numerals have been changed.)

In the above-cited description of Patent Literature 1, the camera control section 308 may be referred to as “camera control circuit 308” in the below. Also, CMOS stands for “complementary metal-oxide-semiconductor”. CDS stands for “correlated double sampling”, and in the below, the CDS 304 is referred to as “CDS circuit 304”. AGC stands for “automatic gain control”, and in the below, the AGC 305 is referred to as “AGC circuit 305”. A/D stands for “analog/digital”, and in the below, the A/D 306 is referred to as “A/D converter 306”. DSP stands for “digital signal processor”. CPU stands for “central processing unit”. ROM stands for “read-only memory”. RAM stands for “random access memory”. LSI stands for “large-scale integrated circuit”. In the present embodiment, the digital signal processing section (measurement value determination circuit) 6 calculates a measurement value of a distance by execution of a program for distance measurement value determination, the program being stored in the ROM, by the CPU. In an example, the measurement value determination circuit 6 determines a measurement value of a distance according to, e.g., d=Bf/p for each of pixels included in both of respective images shot by the cameras C0, C1, generates a distance image in which a color of each pixel is a color corresponding to the distance measurement value of the pixel, and outputs a measurement value corresponding to a distance between an object element and the unmanned aerial vehicle 1, the measurement value being obtained from data of the distance image, to the main operation circuit 7a.

Although the principle of distance measurement and the configurations of the stereo camera 3 and the measurement value determination circuit 6 have been described above with citations of FIGS. 1 and 5 and paragraphs [0003] and [0004] and [0030] to [0036] of Patent Literature 1, a shooting camera and a measurement value determination circuit other than the stereo camera 3 and the measurement value determination circuit 6 can be used to determine a distance between a subject (object element) and the unmanned aerial vehicle 1. For example, instead of the stereo camera 3, use of a monocular camera to shoot (take an image of) an object element twice with a short time interval in such a manner that positions of the monocular camera at the respective times of shooting are similar to the positions of the cameras C0, C1 in FIG. 6 (the positions are detected by the sensor section 14 and input to the measurement value determination circuit 6 via the main operation circuit 7a) enables measurement of a distance on a principle that is similar to the above, which is, though, inferior in precision in comparison with a stereo camera. Also, the “Imaging Technique That Can Simultaneously Acquire a Color Image and Distance Image from a Single Image Taken with a Monocular Camera” (Non-Patent Literature 1) has been developed by Toshiba Corporation and a distance may be measured using this technique. Also, provision of a zoom lens in the shooting camera enables enhancement in measurement precision.

Note that in an example, a signal indicating a measurement value of a distance, the signal being output from the measurement value determination circuit 6 to the main operation circuit 7a, may be a signal indicating a signal indicating a smallest distance from among distances of respective pixels included in a distance image generated by the measurement value determination circuit 6 (in this case, an element that is a smallest distance away from the unmanned aerial vehicle 1 from among elements included in a shot image is the “object element”) or it is possible that: a particular element may be detected as an object by operation of the measurement value determination circuit 6 according to an arbitrary image processing algorithm; and the measurement value determination circuit 6 determines a distance between the element and the unmanned aerial vehicle 1 on the above-described principle and outputs a signal indicating the distance to the main operation circuit 7a. For example, a particular object can be detected based on a contour thereof from a shot image by means of an image processing function of OpenCV (Open Source Computer Vision Library), which is an open source library released to the public by Intel Corporation (Non-Patent Literature 2). In this case, such an image processing program as above is installed in advance in the memory of the measurement value determination circuit 6, and execution of the image processing program by the processor of the measurement value determination circuit 6 enables detection of a particular element from image information recorded in the frame memory 307 and determination of a distance between the element and the unmanned aerial vehicle 1.

### Distance Control According to Distance Measurement Value

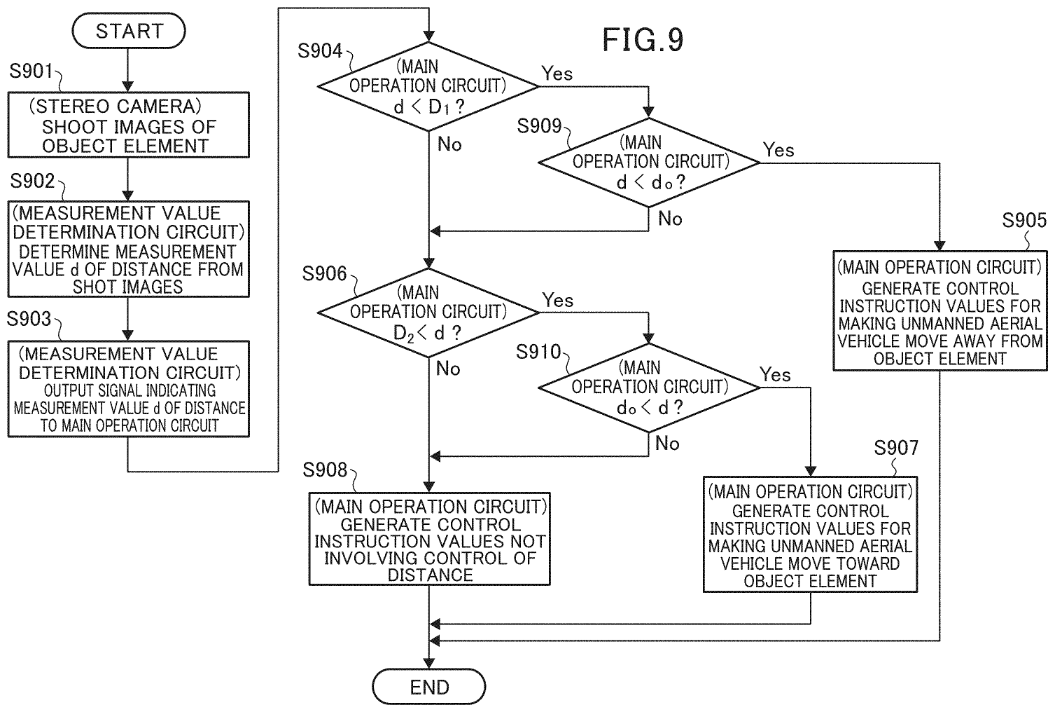

As indicated in steps S401 to S403 above, upon determination of a measurement value d of a distance and output of a signal indicating the distance to the main operation circuit 7a, the main operation circuit 7a performs processing in step S404 onwards by means of execution of the autonomous control program 9a including the distance control module 9b. Note that steps S401 to S403 are repeated at a predetermined time interval, and therefore, the entire processing according to the processing flow in FIG. 4 and the subsequent control processing are also repeated at a predetermined time interval; however, it is not essential to determine a measurement value d of a distance for each frame of an image (moving image) shot by the stereo camera 3 and output a signal indicating the distance to the main operation circuit 7a, but, for example, the processing in the entire flowchart in FIG. 4 may be performed once per 10 frames in shooting. The same applies to the alteration in FIG. 9.

In the present embodiment, the unmanned aerial vehicle 1 flies around an inspection object structure 15a, which is an object element, under the control according to (combined) control instruction values obtained by combining external input instruction values input in real time during flight from external input signals from the proportional controller (instruction values for the throttle amount, the roll angle, the pitch angle and the yaw angle) and attitude control instruction values generated using data from the attitude sensor by execution of the autonomous control program 9a by the main operation circuit 7a (instruction values relating to the roll angle, the pitch angle and the yaw angle) (in an example, the throttle amount according to the external input instruction value is used as the instruction value relating to the throttle amount, and an instruction value that is a sum of instruction values for the roll angle in the external input instruction values and the attitude control instruction values, an instruction value that is a sum of instruction values for the pitch angle in the external input instruction values and the attitude control instruction values and an instruction value that is a sum of instruction values for the yaw angle in the external input instruction values and the attitude control instruction values are used as instruction values relating to the roll angle, the pitch angle and the yaw angle, respectively) (FIG. 7A).

Upon input of the signal indicating the measurement value d of the distance, the main operation circuit 7a executes the distance control module 9b to compare the measurement value d with a first reference value D₁ (which is recorded in advance in the recording apparatus 10 by, e.g., an external input and is read by execution of the distance control module 9b by the main operation circuit 7a. The same applies to a second reference value D₂) (step S404). If the measurement value d is smaller than the first reference value D₁ (Yes), as illustrated in FIG. 7B, the unmanned aerial vehicle 1 is too close to the inspection object structure 15a, and thus, control instruction values for making the unmanned aerial vehicle 1 move away from the inspection object structure 15a are generated (step S405). In an example, in order to make the unmanned aerial vehicle 1 move rearward (direction opposite to the x direction in FIG. 1), the amount relating to the pitch angle, from among the combined control instruction values relating to the throttle amount, the roll angle, the pitch angle and the yaw angle, which are combinations of the external input instruction values and the attitude control instruction values, is updated to an amount corresponding to rotation of the airframe in the direction of the arrow indicating the pitch angle in FIG. 1 (the front part of the airframe ascends and the rear part of the airframe descends), to generate control instruction values for making the unmanned aerial vehicle 1 move away from the inspection object structure 15a.

In step S404, if the measurement value d is not smaller than the first reference value D₁ (No), the unmanned aerial vehicle 1 is not too close to the inspection object structure 15a, the processing in step S405 is not performed and the processing proceeds to step S406. The main operation circuit 7a executes the distance control module 9b to compare the measurement value d with the second reference value D₂ (step S406). Here, the second reference value D₂ is a reference value that is equal to or larger than the first reference value D₁. If the measurement value d is larger than the second reference value D₂ (Yes), as illustrated in FIG. 7C, the unmanned aerial vehicle 1 is too far away from the inspection object structure 15a, a control instruction value for moving the unmanned aerial vehicle 1 toward the inspection object structure 15a is generated (step S407). In an example, in order to make the unmanned aerial vehicle 1 move forward (the x direction in FIG. 1), the amount relating to the pitch angle, from among combined control instruction values relating to the throttle amount, the roll angle, the pitch angle and the yaw angle, which are combinations of the external input instruction values and the attitude control instruction values, is updated to an amount corresponding to rotation of the airframe in a direction opposite to the arrow indicating the pitch angle in FIG. 1 (the front part of the airframe descends and the rear part of the airframe ascends), to generate control instruction values for making the unmanned aerial vehicle 1 move toward the inspection object structure 15a.

In step S406, if the measurement value d is not larger than the second reference value D₂ (No), the unmanned aerial vehicle 1 is not too far away from the inspection object structure 15a, the processing in step S407 is not performed and the processing proceeds to step S408. The main operation circuit 7a generates control instruction values relating to the throttle amount, the roll angle, the pitch angle and the yaw angle as (combined) control instruction values obtained by combining the external input instruction values and the attitude control instruction values (step S408).

According to the processing flow in FIG. 4, the control instruction values relating to the throttle amount, the roll angle, the pitch angle and the yaw angle are generated in any of steps S405, S407 and S408. Subsequently, the main operation circuit 7a executes the autonomous control program 9a to convert these control instruction values to control instruction values relating to the rotation speeds of the rotors R1 to R6, and the signal conversion circuit 7b converts these control instruction values into pulse signals to generate control signals and the speed controllers ESC1 to ESC6 converts the respective pulse signals into drive currents and output the drive currents to the motors M1 to M6 to control driving of the motors M1 to M6 to control, e.g., the rotation speeds of the rotors R1 to R6 and thereby control flight of the unmanned aerial vehicle 1. Consequently, the distance d between the unmanned aerial vehicle 1 and the inspection object structure 15a is controlled so as to fall within a range of from the first reference value D₁ to the second reference value D₂. The flow processing in FIG. 4 and the subsequent control processing are repeated at a predetermined time interval, and thus, unless the unmanned aerial vehicle 1 falls within the range of from the first reference value D₁ to the second reference value D₂, the unmanned aerial vehicle 1 is continuously controlled so as to fall within that range.

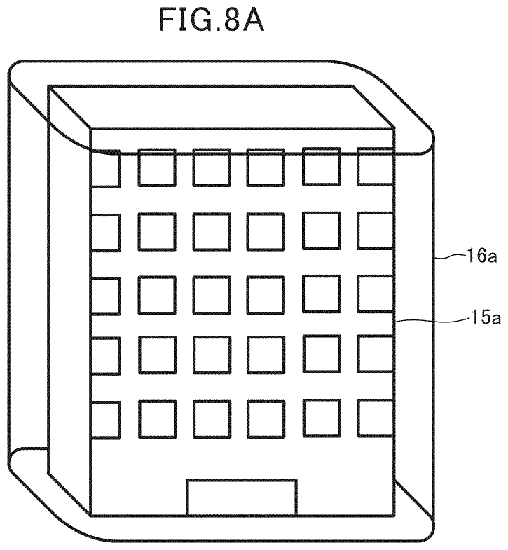

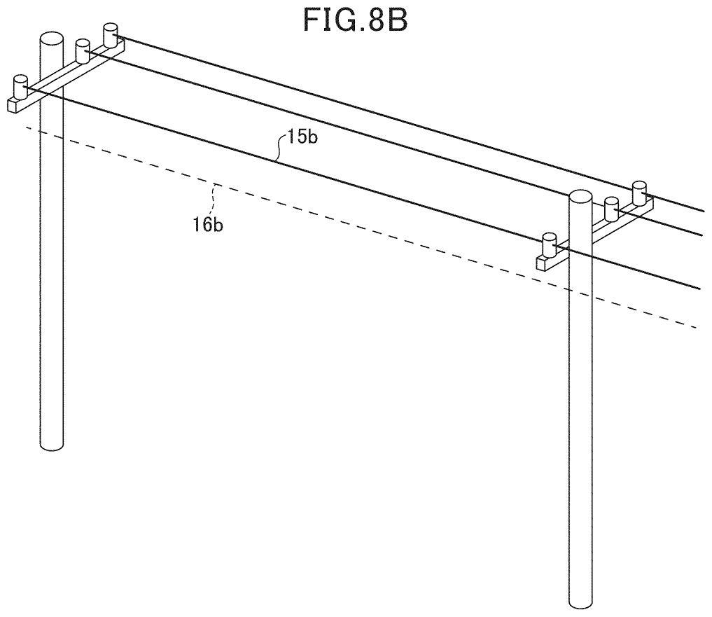

Here, if the first reference value D₁ and the second reference value D₂ are equal to each other, the distance d between the unmanned aerial vehicle 1 and the inspection object structure 15a is controlled so as to become a constant distance that is equal to the reference value (FIG. 7D). In this case, flight of the unmanned aerial vehicle 1 is controlled so as to fall within an equidistant plane 16a that is equidistant from the inspection object structure 15a (FIG. 8A), and a flight route of the unmanned aerial vehicle 1 can substantially be two-dimensioned. If the object element is not the inspection object structure 15a but an inspection object element 15b such as an electric wire, the distance d between the unmanned aerial vehicle 1 and the inspection object element 15b is controlled on a principle that is similar to the above, and thus, flight of the unmanned aerial vehicle 1 can be controlled to be on an equidistant line 16b that is equidistant from the inspection object element 15b and substantially be one-dimensioned (FIG. 8B).

Note that whether or not the distance control illustrated in FIG. 4 is performed is switched, in an example, by the communication antenna 12 and the communication circuit 13 receiving a mode switching signal transmitted from the proportional controller, the main operation circuit 7 a and executing the autonomous control program in response to the input of the mode switching signal. Consequently, it is possible to perform control to, e.g., make the unmanned aerial vehicle 1 move toward the inspection object structure 15a and make the stereo camera 3 face toward the inspection object structure 15a, and then transmit a mode switching signal for turning on a distance control mode from the proportional controller to the communication antenna 12 for transition to the distance control mode and perform inspection work (image information of an image shot by the stereo camera 3 being output in the form of a still image or a moving image from the measurement value determination circuit 6 to the main operation circuit 7a and, as necessary, being transmitted to an external computer of an operator via the communication circuit 13 and the communication antenna 12 enables a real-time inspection and also enables recording the still image or the moving image in the recording apparatus 10 and reading the still image or the moving image out after an end of the flight. The unmanned aerial vehicle 1 may include a camera that is separate from the stereo camera 3 as a camera for inspection to use image information of an image shot by the separate camera in such a manner as above), and after an end of the work, transmit a mode switching signal for turning off the distance control mode from the proportional controller to the communication antenna 12 to terminate the distance control mode and make the unmanned aerial vehicle 1 return.

As already described, the unmanned aerial vehicle 1 flies under the control using (combined) control instruction values obtained by combining external input instruction values input in real time and attitude control instruction values generated by execution of the autonomous control program 9a; however, even where the unmanned aerial vehicle 1 flies according to control using the above-described flight plan information, distance measurement and distance control can be performed in such a manner as above. The control flow is basically similar to the flow illustrated in FIG. 4, and, for example, in step S405, where control instruction values for making the unmanned aerial vehicle 1 move away from the inspection object structure 15a are generated, the main operation circuit 7a executes the autonomous control program 9a using the control instruction values to perform control so that the unmanned aerial vehicle 1 flies in a direction away from the inspection object structure 15a and furthermore, changes a flight plan route included in flight plan information recorded in the recording apparatus 10 so that the flight plan route is diverted in the direction away from the inspection object structure 15a without running through a position of the unmanned aerial vehicle 1 at the time of execution of step S405. Alternatively, for example, in step S407, where control instruction values for making the unmanned aerial vehicle 1 move toward the inspection object structure 15a are generated, the main operation circuit 7a executes the autonomous control program 9a using the control instruction values to perform control so that the unmanned aerial vehicle 1 flies in a direction toward the inspection object structure 15a, and furthermore, changes the flight plan route included in the flight plan information recorded in the recording apparatus 10 so that the flight plan route is diverted in the direction toward the inspection object structure without running through a position of the unmanned aerial vehicle 1 at the time of execution of step S407. The processing according to the flow in FIG. 4 and the subsequent control processing are repeated at a predetermined time interval, and thus, unless the unmanned aerial vehicle 1 falls within the range of from the first reference value D₁ to the second reference value D₂, the unmanned aerial vehicle 1 is continuously controlled so as to fall within that range, and the flight plan route is continuously changed. Even where the unmanned aerial vehicle 1 flies in a mode in which when no external input signals have been received, the unmanned aerial vehicle 1 flies under the control using flight plan information and when external input signals have been received, the control is temporarily changed to manual control with priority placed on control according to the external input instruction values, distance measurement and distance control can be performed in such a manner as above, and in an example, as already described above, in conjunction with generation of control instruction values for making the unmanned aerial vehicle 1 move away from the inspection object structure 15a or move toward the inspection object structure 15a, the flight plan route is changed to a route diverted in a direction away from the inspection object structure 15a or diverted in a direction toward the inspection object structure 15a. Likewise, the processing according to the below-described flowchart in FIG. 9 can be performed for any of various flight modes of an unmanned aerial vehicle.

FIG. 9 illustrates an alteration of the above-described flowchart in FIG. 4. The processing in steps S901 to S908 is similar to the processing in steps S401 to S408 in FIG. 4 and description thereof will appropriately be omitted. In the flowchart in FIG. 9, comparison processing in steps S909 and S910 is newly added.

In steps S901 to S903, as in steps S401 to S403 in FIG. 4, during flight of the unmanned aerial vehicle 1, the stereo camera 3 shoots (takes images of) an object element (inspection object structure 15a) (step S901), and the measurement value determination circuit 6 determines a measurement value d of a distance between the unmanned aerial vehicle 1 and the inspection object structure 15a, using image information of the images simultaneously shot by left and right cameras C0, C1 (see FIGS. 5 and 6) (step S902). The measurement value determination circuit 6 outputs a signal indicating the measurement value d of the distance to the main operation circuit 7a (step S903). As in the flowchart of FIG. 4, the processing flow in FIG. 9 and the subsequent control processing are repeated at a predetermined time interval, that is, a signal indicating a measurement value d of a distance determined by each distance measurement is continuously input to the main operation circuit 7a; here, the main operation circuit 7a continuously records the measurement value d of the distance indicated by the input signal in the recording apparatus 10 in association with a measurement time corresponding to the measurement value d (time of reception of the signal input), in the form of data of a set of the measurement value d and the corresponding measurement time.

Upon reception of the input of the signal indicating the measurement value d of the distance, the main operation circuit 7a executes the distance control module 9b to compare the measurement value d with a first reference value D₁ (step S904). If the measurement value d is smaller than the first reference value D₁ (Yes), the main operation circuit 7a further executes the distance control module 9b to compare the measurement value d (latest measurement value) and a last measurement value do of the distance indicated by a signal received last time from the measurement value determination circuit 6 (S909). If the latest measurement value d is smaller than the last measurement value do (Yes), the unmanned aerial vehicle 1 is too close to the inspection object structure 15a and the measurement value of the distance is decreasing over time, and thus, control instruction values for making the unmanned aerial vehicle 1 move away from the inspection object structure 15a are generated (step S905). Note that if the main operation circuit 7a has received an input of a signal indicating a measurement value of a distance according to first measurement and there is thus no “last” measurement value, the comparison in step S909 is omitted (regarded as “Yes”) and the processing in step S905 is performed.

In step S904, if the measurement value d is not smaller than the first reference value D₁ (No) or if the measurement value d is smaller than the first reference value D₁ but the latest measurement value d is not smaller than the last measurement value do in step S909 (No), the unmanned aerial vehicle 1 is not too close to the inspection object structure 15a or is moving away from the inspection object structure 15a or is kept an equal distance from the inspection object structure 15a, and thus the processing in step S905 is not performed and the processing proceeds to step S906. The main operation circuit 7a executes the distance control module 9b to compare the measurement value d with the second reference value D₂ (step S906). As already described, the second reference value D₂ is a reference value that is equal to or larger than the first reference value D₁. If the measurement value d is larger than the second reference value D₂ (Yes), the main operation circuit 7a further executes the distance control module 9b to compare the measurement value d (latest measurement value) and the last measurement value d₀ of the distance indicated by the signal received last time from the measurement value determination circuit 6 (S910). If the latest measurement value d is larger than the last measurement value do (Yes), the unmanned aerial vehicle 1 is too far away from the inspection object structure 15a and the measurement value of the distance is increasing over time, and thus, control instruction values for making the unmanned aerial vehicle 1 move toward the inspection object structure 15a are generated (step S907). Note that if the main operation circuit 7a has received an input of a signal indicating a measurement value of the distance according to first measurement and there is thus no “last” measurement value, the comparison in step S910 is omitted (regarded as Yes) and the processing in step S907 is performed.

In step S906, if the measurement value d is not larger than the second reference value D₂ (No) or if the measurement value d is larger than the second reference value D₂ but the latest measurement value d is not larger than the last measurement value do in step S910 (No), the unmanned aerial vehicle 1 is not too far away from the inspection object structure 15a or is moving toward the inspection object structure 15a or is kept an equal distance from the inspection object structure 15a, and thus, the processing in step S907 is not performed and the processing proceeds to step S908. The main operation circuit 7a generates control instruction values relating to the throttle amount, the roll angle, the pitch angle and the yaw angle as (combined) control instruction values obtained by combining the external input instruction values and the attitude control instruction values (step S908).

According to the processing flow in FIG. 9, the control instruction values relating to the throttle amount, the roll angle, the pitch angle and the yaw angle are generated in any of steps S905, S907 and S908. The subsequent control instruction value conversion and control signal generation are as already described with reference to FIG. 4.

### Prototype

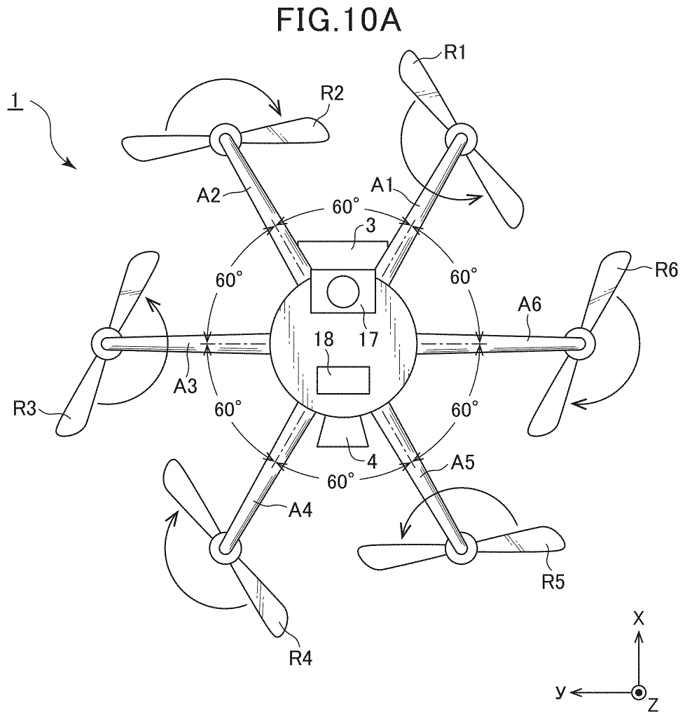

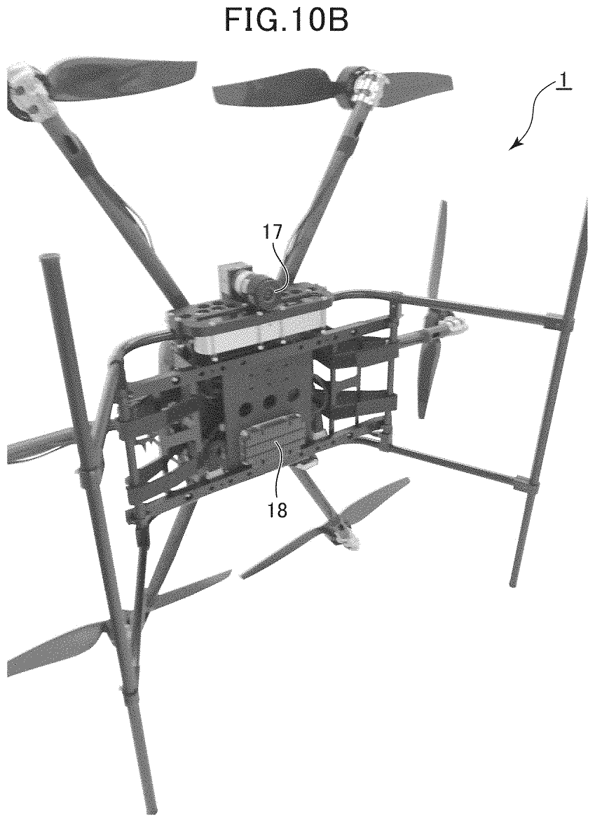

The present inventor has designed a prototype of the unmanned aerial vehicle 1 according to the present invention in which distance measurement and distance control according to the distance measurement are performed. However, the present prototype includes, in addition to various sensors of the sensor section 14 in the configuration in FIG. 3, a downward camera 17 and an SLAM (simultaneous localization and mapping) processing circuit 18 as illustrated in the diagram and the photo as viewed from the lower side (the z-direction in FIG. 1) and a direction slightly oblique to that direction in FIGS. 10A and 10B, and the block diagram in FIG. 11, respectively. However, in FIG. 10A, the landing gear 5 is omitted. The downward camera 17 is a monocular camera that shoots (takes an image of) the lower side (the z-direction in FIG. 1) during flight, and, as with the stereo camera in FIG. 6, includes a CDS circuit, an AGC circuit, an A/D converter and a frame memory and performs signal processing and recording of the shot image by means of these components. The SLAM processing circuit 18 is a commercially available circuit board including, e.g., a CPU, a GPU (graphics processing unit) and a memory, and is used with e.g., a program for executing Visual SLAM and data recorded in the memory. Visual SLAM is a technique that performs estimation of a self-location and a map in parallel by tracking a plurality of feature points through a plurality of frames of the images successively shot, and various algorithms such as MonoSLAM (Non-Patent Literature 3) and PTAM (parallel tracking and mapping) (Non-Patent Literatures 4 and 5) have been developed. The SLAM processing circuit 18 executes the program with any of such algorithms implemented therein, to perform self-location estimation and mapping according to Visual SLAM using image signals recorded in the frame memory of the downward camera 17 and thereby determine amounts representing a status of the unmanned aerial vehicle 1, such as the estimated self-location (position of the unmanned aerial vehicle 1 relative to an element present around the unmanned aerial vehicle 1), a speed (which can be obtained by temporal differentiation of the position) and an attitude (which can be obtained by geometric calculation from disposition of the plurality of feature points in the shot images), the amounts being determined using sensor data from the sensor section 14 in the configuration in FIG. 3. The signal indicating these amounts is output to the main operation circuit 7a, and then, the main operation circuit 7a uses information input from the SLAM processing circuit 18, in such a manner as the main operation circuit 7a uses information input from the sensor section 14 in the configuration in FIG. 3. Also, information of the map estimated by the SLAM processing circuit 18 is output to the main operation circuit 7a and recorded in the recording apparatus 10. A configuration of the prototype is basically similar to the configuration described with reference to FIGS. 1 to 9 except the configuration related to SLAM. Note that for the downward camera 17, not a monocular camera but the stereo camera described with reference to FIGS. 5 and 6 may be used, and in this case, also, estimation of, e.g., a self-location using Visual SLAM can be performed on a principle that is similar to the above. Not Visual SLAM but, for example, SLAM using a laser distance sensor can be employed, and in this case, a laser distance sensor is used instead of the downward camera 17 (Non-Patent Literature 6).

A specific configuration of the present prototype will be described below. The present prototype includes a barometric altimeter, a sonar and a GPS sensor in a sensor section 14, and mainly, if highly reliable data of, e.g., an airframe location fails to be obtained by Visual SLAM processing using the downward camera 17 and the SLAM processing circuit 18, the operation is switched to detection processing using the sensors in the sensor section 14. Note that transmission of data such as an airframe location from the SLAM processing circuit 18 to the main operation circuit 7a is performed via a 3.3V UART (universal asynchronous receiver/transmitter) interface using a single data line.

As a hardware configuration, a NVIDIA Jetson TX2 (vision computer) and a CTI Orbitty carrier board for NVIDIA Jetson TX2 are used for a circuit board of the SLAM processing circuit 18, a ZED stereo camera (USB 3.0) is used for the stereo camera 3 and an IDS UI-1220 SE mono grayscale camera (USB 2.0) and a Theia MY110M lens for mono camera are used for the downward camera 17.

Note that operating power of the SLAM processing circuit 18 of the above configuration is basically 2 W and 9V to 14V is thus needed and the power is obtained from a power supply system 11 (main battery) of the airframe body. The unmanned aerial vehicle 1 is activated or deactivated by a power supply button (not illustrated) provided in the body of the unmanned aerial vehicle 1 being pressed, and the operation of the SLAM processing circuit 18 is turned on or off along with the operation of the body of the unmanned aerial vehicle 1 being turned on or off. For example, upon the power supply button being pressed in order to stop operation of the body of the unmanned aerial vehicle 1, first, a stop instruction signal is transmitted from the main operation circuit 7a to the SLAM processing circuit 18, the SLAM processing circuit 18 thereby stops operation and the operation of the body then stops. In order to enable the SLAM processing circuit 18 to be shut down after the main battery being turned off, a backup battery having a sufficient capacity may separately be provided in the SLAM processing circuit 18.

While the present prototype is basically operated via an external input device such as a proportional controller, the present prototype is capable of overriding an input signal from, e.g., the proportional controller by means of change processing according to a status during flight (for example, when an obstacle in a close range has been detected, the above-described distance control processing via, e.g., the control signal generation circuit 8 is performed and an external input signal is changed) or change processing according to an input of a command from the outside (flight can forcedly interrupted by transmitting an emergency command for, e.g., as a temporary halt or a forced halt from, e.g., a ground station). The present prototype can operate in five modes below.

### 1. Attitude Control Mode

The attitude control mode is a semi-manual mode in which an attitude is autonomously controlled by generating (combined) control instruction values by combining external input instruction values indicated by external input signals received from the external input device and attitude control instruction values generated by execution of an autonomous control program 9a by the main operation circuit 7a using data of attitude information obtained by measurement by the sensor section 14. In order to make the unmanned aerial vehicle 1 take off, it is only necessary to simply press a “thrust” stick upward until the airframe takes off, and subsequently, the airframe can be operated according to an external input signal while the attitude being stabilized by autonomous control. For landing, it is only necessary to simply press the “thrust” stick downward until the airframe lands. Takeoff and landing can be performed in any of modes including the below modes and the procedure is the same in each of the modes except a later-described GPS waypoint mode (in which takeoff and landing are autonomously performed).

### 2. Vision Assist Mode

As already described, the vision assist mode is a mode using information such as an airframe position, a speed and an attitude obtained by Visual SLAM processing by the downward camera 17 and the SLAM processing circuit 18 instead of the sensor section 14. The vision assist mode is a semi-manual mode in which control is performed by generating (combined) control instruction values by combining an external input instruction values indicated by external input signals and autonomous control instruction values generated by execution of the autonomous control program 9a by the main operation circuit 7a using information obtained by Visual SLAM processing. In this control mode, when an operator moves his/her fingers away from the external input device, the unmanned aerial vehicle 1 stays at the current airframe position. In order to make the unmanned aerial vehicle 1 move to the left, press a “roll” stick to the left. In order to make the unmanned aerial vehicle 1 stop, it is only necessary to simply move the hand away from the stick. In order to make the unmanned aerial vehicle 1 move upward, press the “thrust” stick upward. In order to make the unmanned aerial vehicle 1 stop, it is only necessary to simply release the stick (a spring is incorporated in the “thrust” stick and the “thrust” stick thus returns to a middle position).

### 3. Distance Control Mode

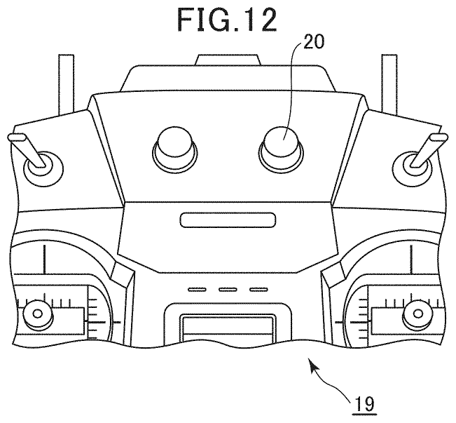

In the present prototype, the distance control mode is a mode to be used together with the vision assist mode in “2.” above, in which distance control is performed so that a fixed distance to a closest object element (e.g., a wall, a truss or a wire) present in front of the unmanned aerial vehicle 1 is maintained on the principle already described. Leftward/rightward and upward/downward flight control can be used for making the airframe “slide” along the object element present in front of the unmanned aerial vehicle 1. A target value of the fixed distance is set within a range of from a minimum of 1 m to a maximum of 3 m, using a distance setting knob 20 at the external input device 19 (FIG. 12).

### 4. GPS Assist Mode

The GPS assist mode is a mode of basically operating according to control signals from an external controller and autonomous control of an attitude and a position (during hovering) is performed based on GPS sensor data.

### 5. GPS Wavpoint Mode

The GPS waypoint mode is a mode of autonomously flying on a flight plan route using, e.g., position data from the GPS sensor according to a flight plan provided by flight plan information using GPS waypoints set in advance as parts of the flight plan information.

The flight mode is selected using a mode switch (not illustrated) on the external input device. However, the distance control mode in “3.” is ineffective during a takeoff motion and a landing motion.

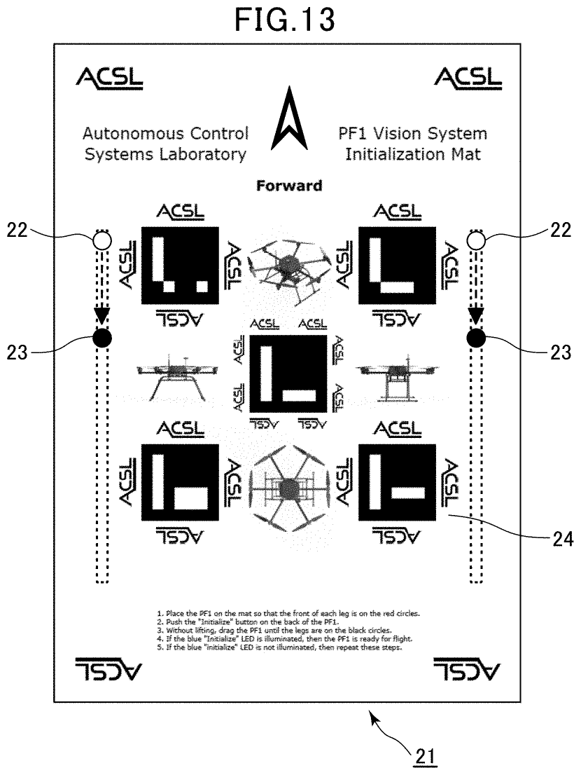

Also, before making the present prototype fly, setup work using a takeoff pad 21 in FIG. 13 is performed for initialization of Visual SLAM processing. A procedure for the setup is as follows.
1. Confirm that the external input device (radio controller) is off.
2. Plug in the airframe battery.
3. Press a “vision power” button of the airframe.
   a. A “vision power” LED starts blinking in yellow.
   b. Wait until the “vision power” LED turns into plain green.
4. Place the airframe on the takeoff pad 21.
   a. Place the airframe in such a manner that a stereo camera 3 faces in the arrow (forward) direction in FIG. 13.
   b. Also, place the airframe in such a manner that front two end portions of the landing gear 5 are positioned at respective first marks 22.
5. Press an “Initialize” button at a back portion of the airframe.
6. Move the airframe so that the front two end portions of the landing gear 5 slide from the first marks 22 to second marks 23.
7. Confirm that an “Initialize” LED at the back portion of the airframe has gone out. If the “Initialize” LED does not go out, repeat the work from step 4.

This setup work is intended to acquire first two images to be used for Visual SLAM processing by shooting an initial setting picture 24 in each of a first fixed position in which the front two end portions of the landing gear 5 of the airframe are located at the respective first marks 22 and a second fixed position in which the front two end portions are located at the respective second marks 23, via the downward camera 17. During the setup work, an initial setting picture 24 is shot in the first fixed position when the work in “5.” above is performed, and an initial setting picture 24 is shot in the second fixed position when the work in “6.” above is performed. A relative attitude between the downward camera 17 and a 3D position of a feature point observed can be calculated by finding homography between the cameras via a plane. Each of markers (patterns) in each initial setting picture 24 has a known size and an actual distance from the downward camera 17 to the takeoff pad 21 can be determined using the shot images. This actual distance is compared with a distance from a surface of the takeoff pad 21, which can be obtained from an initial SLAM map, and a scale (ratio) between SLAM processing and the real world can be set. Note that where a stereo camera is used for the downward camera 17, two images can be obtained by shooting an initial setting picture 24 in the first fixed position, and thus the work “6.” above can be omitted.

### INDUSTRIAL APPLICABILITY

The present invention is applicable to control of any unmanned aerial vehicle to be used for all uses including industrial use and recreational use.

### REFERENCE SIGNS LIST

1 unmanned aerial vehicle
2 body portion
3 stereo camera
4 external environment shooting camera
5 landing gear
6 measurement value determination circuit (digital signal processing section)
7a main operation circuit
7b signal conversion circuit
8 control signal generation circuit
9a autonomous control program
9b distance control module
9c various databases
10 recording apparatus
11 power supply system
12 communication antenna
13 communication circuit
14 sensor section
C0 left camera
C1 right camera
A subject
O₀, O₁ optical center
s₀, s₁ imaging surface
P₀, P₁ image position
300 camera section
301 lens
302 diaphragm
303 CMOS image sensor
304 CDS circuit
305 AGC circuit
306 A/D converter
307 frame memory
308 camera control section (camera control circuit)
15a inspection object structure
15b inspection object element
16a equidistant plane
16b equidistant line
17 downward camera
18 SLAM processing circuit
19 external input device
20 distance setting knob
21 takeoff pad
22 first mark
23 second mark
24 initial setting picture

1. An unmanned aerial vehicle flight control device comprising:
a distance sensor that measures a distance between an unmanned aerial vehicle and an object element, the unmanned aerial vehicle flying according to control using an external input signal and/or in advance-generated flight plan information, the distance sensor including a shooting camera that takes an image of the object element and a measurement value determination circuit that determines a measurement value of the distance using information of the taken image; and
a control signal generation circuit that generates a control signal for controlling the distance between the unmanned aerial vehicle and the object element during flight, depending on the measurement value of the distance measured by the distance sensor.

2. The flight control device according to claim 1, wherein the unmanned aerial vehicle is an unmanned aerial vehicle that flies according to control using at least the external input signal, the external input signal is a signal input in real time from an external input device during flight of the unmanned aerial vehicle, and the control signal is a signal obtained by changing the external input signal according to the measurement value of the distance.

3. The flight control device according to claim 1, wherein the unmanned aerial vehicle is an unmanned aerial vehicle that flies according to control using at least the flight plan information, and the flight plan information is flight plan information generated in advance before the flight by execution of a program by a computer.

4. The flight control device according to any one of claims 1 to 3, wherein the measurement value determination circuit is integrated in the control signal generation circuit.

5. The flight control device according to any one of claims 1 to 4, wherein the control signal generation circuit is configured to, if the measurement value is smaller than a first reference value, generate a control signal for making the unmanned aerial vehicle move away from the object element.

6. The flight control device according to claim 5, wherein the control signal generation circuit is configured to, if the measurement value is larger than a second reference value that is equal to or larger than the first reference value, generate a control signal for making the unmanned aerial vehicle move toward the object element.

7. The flight control device according to claim 6, wherein the first reference value and the second reference value are equal to each other.

8. The flight control device according to claim 6 or 7, wherein the control signal generation circuit is configured to:
if the measurement value is smaller than the first reference value and the measurement value decreases over time, generate a control signal for making the unmanned aerial vehicle move away from the object element; and
if the measurement value is larger than the second reference value and the measurement value increases over time, generate a control signal for making the unmanned aerial vehicle move toward the object element.

9. The flight control device according to any one of claims 1 to 8, further comprising an external environment shooting camera that performs image shooting in a direction that is different from a direction of taking of image by the shooting camera.

10. The flight control device according to any one of claims 1 to 9, further comprising a relative position measurement sensor for measuring a relative position of the unmanned aerial vehicle relative to an element present around the unmanned aerial vehicle.

11. The flight control device according to any one of claims 1 to 10, wherein the object element is a structure to be inspected.

12. An unmanned aerial vehicle comprising the flight control device according to any one of claims 1 to 11.

13. An unmanned aerial vehicle flight control method comprising:
measuring a distance between an unmanned aerial vehicle and an object element, the unmanned aerial vehicle flying according to control using an external input signal and/or in advance-generated flight plan information, by taking an image of the object element and determining a measurement value of the distance using information of the taken image; and
generating a control signal for controlling the distance between the unmanned aerial vehicle and the object element during flight, depending on the measurement value of the distance.

14. A program for
making a measurement value determination circuit determine a measurement value of a distance between an unmanned aerial vehicle and an object element, the unmanned aerial vehicle flying according to control using an external input signal and/or in advance-generated flight plan information, using information of an image of the object element, the image being taken by a shooting camera, and
making a control signal generation circuit generate a control instruction value for controlling the distance between the unmanned aerial vehicle and the object element during flight, depending on the measurement value of the distance.
